(19) United States
(12) Patent Application Publication
(10) Pub. No.: US 2024/0116785 A1
(43) Pub. Date: Apr. 11, 2024

(54) COMPOSITIONS AND METHODS FOR TREATING WATER BY STABILIZING IN SITU GENERATED OXIDANTS

(71) Applicant: CHEMTREAT, INC., Glen Allen, VA (US)

(72) Inventors: Douglas MCILWAINE, Ashland, VA (US); Rajendra Prasad KALAKODIMI, Glen Allen, VA (US); William HENDERSON, Richmond, VA (US); Jack BLAND, Richmond, VA (US)

(73) Assignee: CHEMTREAT, INC., Glen Allen, VA (US)

(21) Appl. No.: 18/368,984

(22) Filed: Sep. 15, 2023

Related U.S. Application Data
(60) Provisional application No. 63/407,457, filed on Sep. 16, 2022.

(51) Int. Cl. C02F 1/50; A01N 25/22; C02F 1/72; C02F 1/76

(52) U.S. Cl. CPC C02F 1/50; A01N 25/22; C02F 1/722; C02F 1/76; C02F 2303/04; C02F 2303/20; C02F 2305/04

(57) ABSTRACT

Methods and compositions for generating stabilized oxidants using a stabilizer composition and an in situ generated oxidant in a water system. The method includes mixing the stabilizer composition and the in situ generated oxidant with water to form a liquid treatment composition, and then adding the liquid treatment composition to a water stream in the water system, the liquid treatment composition improving the efficacy of the in situ generated oxidant in the water stream.

This application claims priority to Provisional Application No. 63/407,457, filed Sep. 16, 2022. The entire contents of the prior application are hereby incorporated by reference herein in their entirety.

### TECHNICAL FIELD

This application is directed to compositions and methods for treating water by stabilizing and increasing the efficacy of in situ generated oxidizing biocides or oxidants in water systems.

### BACKGROUND

Biofouling is a detrimental type of fouling experienced in industrial water treatment applications. Regardless of industry, water treatment experts spend a considerable amount of their time focused on preventing biofouling of heat exchangers and cooling towers. When biofouled, poorly performing heat exchangers and cooling towers can lead to millions of dollars in lost revenues.

The use of oxidizing and non-oxidizing biocides for microbiological control in industrial applications is known. However, the known chemistries have significant drawbacks when it comes to overall efficacy, safety, and delivery.

Methods for combining stabilizers with oxidizing biocides vary, but include: (i) direct injection of the stabilizer into a biocide such as hypochlorite, which is then injected into an aqueous system, (ii) injection of the stabilizing component and biocide such as hypochlorite into the aqueous system separately but in close proximity, and (iii) creating a solid form of a stabilized product, which is then dissolved into an aqueous system.

Whether stabilized or not, oxidizing biocides have difficulty penetrating biofilms once they have been established. While it is possible to feed an exorbitant amount of oxidizing biocide to essentially “burn” the system, the high levels of free oxidant increase corrosion rates throughout the water system. To help improve the oxidizing biocide's ability to penetrate these films and make contact with the microorganisms, biosurfactants have been implemented.

Biosurfactants, sometimes referred to as biodispersants, significantly improve the efficacy of both oxidizing and non-oxidizing biocides. There are subtle differences between biosurfactants and biodispersants, but they have the same function—minimize the growth and adherence of biofilms. Biosurfactants work by actually removing the biofilm in a scrubbing type action, while biodispersants disperse bio matter so that it cannot agglomerate.

Research has shown that biofilms are typically 30 to 40% organic matter, with the rest being inorganic material such as silt, metals, and other particulate matter. Other dispersants, such as sulfonated polymers and copolymers, are sometimes used in conjunction with biodispersants and biosurfactants to help disperse these inorganic materials. While this approach can be effective, it involves a comprehensive and cumbersome water chemistry program.

Conventional efforts have attempted to address these issues by combining stabilizer, surfactant, and a halide ion in a solid form. However, practical application of the solid form in water systems requires special feed systems such as pot feeders and requires manual handling of the chemicals. Other programs have been developed that generate stabilized oxidizing biocides. For example, researchers have combined a stabilizer and a bromine source into a single chemistry, as well as combined a bromine and surfactant into a single chemistry. But these programs require expensive generators, and may pose significant hazards if the systems fail.

Other conventional methods aim to address the above problems. For example, U.S. Pat. No. 10,701,930 to Boudreaux et al., which is hereby incorporated by reference in its entirety, proposes a method for stabilizing an oxidizing biocide, in which an unhalogenated hydantoin is mixed with a surfactant and water to form a liquid treatment composition that is subsequently mixed with calcium hypochlorite, chlorine gas, and/or sodium hypochlorite and then added to a water system in order to improve the efficacy of the oxidizing biocide in a water system. However, recent research by the inventors has uncovered many potential limitations in the application of the conventional methodologies in emerging commercial biocide technology, and in situ generated oxidants in particular.

### SUMMARY

In view of the above, the inventors have conducted extensive research and discovered that selection of certain stabilizers and oxidizing biocides at appropriate concentrations is critical in forming stabilized in situ generated oxidants that effectively treat industrial water systems. It is an object of the disclosed embodiments to provide unique compositions and methods employing stabilizer compositions in a convenient single liquid chemistry that increase the stability and efficacy of a broad range of in situ generated oxidants.

Disclosed compositions and methods result in surprisingly low bio counts/films compared to the oxidizing biocide and in situ generated oxidant treatments alone. Disclosed compositions and methods also result in lower acidity, lower corrosion, and a broader range of persistency compared to commercially available oxidants. Disclosed compositions and methods may also allow for the dual benefit of stabilizing an oxidizing biocide, while simultaneously including a biodispersant or surfactant to improve biofilm removal and penetration. This results in surprisingly lower biocide requirements, less halogenated organics such as trihalomethanes (THM's) and adsorbable organic halides (AOX's), better photostability, and cleaner heat transfer surfaces. A stabilized halogen is also less susceptible to gas-off across the cooling tower.

Additional benefits of the disclosed compositions and methods in comparison to conventional programs include: (1) reduced halogen decomposition due to organics, (2) reduced predisposition of AOX formation, (3) provision of a non-biocidal stabilizer/surfactant blended chemistry, thereby eliminating hazards typically associated with biocide chemistries, (4) improved biofilm removal, thereby allowing halogens to effectively reach microorganisms, (5) more persistent stabilized chemistry, thereby reducing overall biocide feed rates, and thus environmental impact, and (6) safe in situ production that does not require generation equipment.

In embodiments, there is provided a method for treating a water system. The method includes mixing a stabilizer composition and an in situ generated oxidant to form a liquid treatment composition, and then adding the liquid treatment composition to a water stream in the water system, the liquid treatment composition improving the efficacy of the in situ generated oxidant in the water stream. The stabilizer composition is added to the mixture in an amount sufficient to maintain a residual of the in situ generated oxidant in the water stream.

### DETAILED DESCRIPTION

The disclosed embodiments provide a stabilizer composition and methods for mixing the stabilizer composition with in situ generated oxidants, and adding the resultant mixture on site at the point of application. Conventional methods of treatment either require special generation devices to create a stabilized halogen or utilize in situ generated oxidants alone. The methods disclosed herein avoid these drawbacks by providing a stabilizer composition and mixing it with in situ generated oxidants on site for cost-effective, non-hazardous, and environmentally friendly treatment.

In Situ Generated Oxidants

Commercial oxidizing biocides generally include aqueous free halogen species that are effective as powerful anti-microbial agents and chemically reactive with other species. Haloamines are also often used in place of or in addition to free halogen species. Haloamines are less chemically reactive compared to free halogens, and therefore more stable.

In embodiments, the oxidant may include a compound or composition including, but not limited to, chloride, bromide, ammonium, chlorite, chlorate, hypochlorite, hypochlorous acid, hypobromite, hypobromous acid, hydrogen peroxide, ozone chlorine dioxide, chlorite, sodium hypochlorite (NaOCl) (bleach), chlorine gas (Cl₂), bleaching powder or calcium hypochlorite (Ca(OCl)₂), and mixtures thereof. The oxidants are generated on site or in situ in aqueous form. In preferred embodiments, the stabilized oxidants are generated by or facilitated by any suitable method known in the art. For example, formation of in situ generated oxidants may occur by electrochemical generation, or by UV light and/or chemical generation methods. According to conventional thought in the art, electrochemical or UV generation methods would be expected to destroy stabilizer compounds. The inventors surprisingly found that disclosed methods were beneficial in that the stabilizer survived electrochemical or UV generation methods.

In preferred embodiments, the in situ generated oxidant may be a mixture of two or more oxidants/co-oxidants. Mixed oxidants may provide more effective treatment than with single oxidants, such as bleach, alone. Without intending to be bound by theory, it is believed that mixed oxidants results in synergies among oxidants.

For example, hydrogen peroxide is a known co-oxidant used in mixed oxidants and may suitably be paired with a primary oxidant compound including, but not limited to, haloamines, chloride, bromide, ammonium, chlorite, chlorate, hypochlorite, hypochlorous acid, hypobromite, hypobromous acid, ozone chlorine dioxide, chlorite, sodium hypochlorite (NaOCl) (bleach), chlorine gas (Cl₂), and calcium hypochlorite. Peroxide destroys most organic molecules. In situ generated oxidants according to embodiments exhibited efficacious results when peroxide was included alone or in a mixture of oxidants, i.e., the inventors unexpectedly found that use of peroxide with disclosed methods produced a stable and effective oxidant.

Stabilizer Composition

In embodiments, the stabilizer is a compound or mixture that stabilizes the in situ generated oxidant by increasing its efficacy. Given that biocides may be heavily regulated as toxic substances under EPA and other regulations, they are costly to handle and transport. Therefore, in embodiments, the stabilizer maybe transported to the water system on site to be mixed with the in situ generated oxidant. The stabilizer may be non-biocidal, thereby eliminating hazards typically associated with transporting and handling conventional biocide chemistries.

According to embodiments, the stabilizer may be any suitable stabilizer compound or composition including, but not limited to, an unhalogentaed hydantoin, cyanuric acid, or sulfamic acid. Sulfamic acid and its organic compound derivatives, i.e., sulfonamides (e.g., toluenesulfonamide), are chemically distinct from ammonia or other organic amine-containing compounds used to produce haloamines but, like ammonia or many amines, typically contain a nitrogen-hydrogen bond which can react with aqueous halogen species. These compounds can stabilize the electrolyzed halogen species of the in situ generated oxidant.

The hydantoin compound may be, for example, an unhalogentaed alkyl hydantoin. An unhalogentaed alkyl hydantoin is a heterocyclic organic compound the general structure of which is illustrated below.

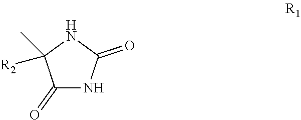

In the above structure, R₁ and R₂ are selected from H, CH₃, C₂H₅, or C₃H₇. Preferably, R₁ and R₂ are both CH₃. The unhalogentaed alkyl hydantoin may be dimethyl hydantoin (DMH).

Hydantoin is a colorless solid that arises from the reaction of glycolic acid and urea. It is an oxidized derivative of imidazolidine. The inventors have found that an unhalogentaed alkyl hydantoin compound is uniquely suited to “stabilize” the oxidizing biocide by the formation of biocidal byproducts such as chloramines through a known reaction of hydantoin with bleach. Chloramines may include, but are not limited to, monochloramine, dichloramine, and organic chloramines. Chloramines provide long-lasting protection and are more stable than pure chlorine products as they do not break down as quickly in water systems. It is known that in the absence of a stabilizer compound, bleach, for example, rapidly and almost completely oxides into chloride.

The stabilizer composition may further include a biodispersant or surfactant. The biodispersant may be any suitable anionic, cationic or nonionic material. Selection of an appropriate class of surfactants that exhibit the requisite stability in the presence of in situ generated oxidants is important so as to maintain functionality of the oxidant. In this regard, industrial oxidants are known to oxidize most surfactants along with target biofilms in water treatment systems. Any biodispersant or surfactant that exhibits stability with in situ generated oxidants would generally be considered suitable for use in the disclosed methods and formulations. For example, the biodispersant or surfactant may be, but is not limited to, any one or more of the following: linear alkylbenzene sulfonate, sodium lauryl sulfoacetate, disodium lauryl sulfosuccinate, sodium dioctyl sulfosuccinate, alkyl polyglycoside, sodium dodecylbenzene sulfonate, nonionic polyoxyethylene, polyoxypropylene block copolymer, ethoxylated alkyl phenol nonionic surfactant, glucoside, terpene-based proprietary dispersant, ethylene oxide/propylene oxide alcohols, polyoxyethylene ether, sodium dodecyl diphenyloxide disulfonate and mixtures thereof. Preferably, the biodispersant or surfactant is an alkyl polyglycoside or ethylene oxide/propylene oxide alcohols. The inventors have found that alkyl polyglycoside and ethylene oxide/propylene oxide alcohols exhibit particularly unexpected stability in the presence of in situ generated oxidants disclosed herein. In other embodiments, the biodispersant or surfactant is a nonionic material having a hydrophilic-lipophilic balance (HLB) of 40 or less, 30 or less, or 20 or less.

In disclosed embodiments, the biodispersant or surfactant may be present in the liquid composition at in a range of 0.01 to 50 ppm, 0.05 to 35 ppm, 0.1 to 20 ppm, or 0.2 to 10 ppm (system). A suitable ratio of concentration of the stabilizer to the biodispersant or surfactant in the stabilizer composition is in a range of 1:1 to 99:1 by volume, preferably 9:1 to 99:1 by volume, and more preferably 19:1 to 99:1 by volume.

In embodiments, an optional halide ion source may also be added to the stabilizer liquid composition. The optional halide ion source may include, but is not limited to, ammonium bromide, sodium bromide, calcium bromide, potassium bromide, sodium iodide, calcium iodide, and potassium iodide and mixtures thereof. In disclosed embodiments, a suitable ratio of concentration of the halide ion source to the stabilizer in the stabilizer composition is in a range of 0.001:1 to 20:1, preferably 0.1:1 to 10:1, and more preferably 0.05:1 to 4:1 by volume.

Methods of Treatment

According to embodiments, the method for stabilizing an in situ generated oxidant in a water system may include mixing the stabilizer composition with water to form a liquid composition according to the formulation described above. Then, this liquid composition can be mixed with the in situ generated oxidant to form a liquid treatment composition and the liquid treatment composition is added to a water stream in the water system, such that the liquid composition treatment improves the efficacy of the oxidizing biocide in the water stream by forming stabilized oxidants.

In embodiments, mixing the stabilizer composition with the in situ generated oxidant may include mixing the stabilizer composition with the in situ generated oxidant on site to form the liquid treatment composition in a water stream of the water system. Adding the liquid treatment composition to the water stream in the water system may include injecting the liquid treatment composition into the water stream of the water system. The stabilizer may be added before, during, or after the in situ generation of oxidants. Mixing the liquid composition with the in situ generated oxidant may include mixing the liquid composition with the in situ generated oxidant separately into a carry water solution to form the liquid treatment composition, and adding the liquid treatment composition to the water stream in the water system may include injecting the carry water solution into the water stream of the water system.

The blending of the stabilizer liquid composition and in situ generated oxidant can be accomplished by direct injection of the in situ generated oxidant into the liquid composition.

This blending may be done by in-line feeding or direct injection of the in situ generated oxidant and the liquid composition separately into carry-water. Once blended, the liquid treatment composition may be added to a water system via a continuous drip feed or slug feed process. This method of applying the unique stabilizer liquid chemistry with the in situ generated oxidant provides a safe and effective means of delivering an effective oxidant program without the use of expensive, complicated generating systems.

The liquid treatment composition may be added based on any suitable system or environmental parameter. Such parameters may include system demands including, but not limited to, the flow rate of the system and oxidant demand of the system.

The in situ generated oxidants should be added from the liquid treatment composition to the water stream at a level suitable to form stabilized oxidants and maintain a residual in the water stream. In order to maintain such a level of residuals, the concentration of the in situ generated oxidants in the liquid treatment composition may be in a range of 0.01 to 100 ppm, 0.1 to 25 ppm, or 0.2 to 10 ppm. The concentration of the stabilizer in the liquid treatment composition may be in a range of a range of 0.005 to 100 ppm, 0.01 to 25 ppm, or 0.1 to 10 ppm. A molar ratio of in situ generated oxidants to stabilizer in the liquid treatment composition may be in a range of 0.01 to 100:1, 0.1 to 40:1, 0.01:1 to 20:1, 1:1 to 10:1, 1:1 to 20:1, 2:1 to 10:1, 3:1 to 7:1, or 4:1 to 6:1.

The stabilized oxidants generated according to embodiments may include, but are not limited to, ClHDMH, Cl₂DMH, ClBrDMH, BrHDMH, Br₂DMH, Cl sulfamic, Br sulfamic, ClH₂ cyanurate, BrH₂ cyanurate, Cl₂H cyanurate, Br₂H cyanurate, ClBrH cyanurate, and mixtures thereof.

In situ generated stabilized oxidants generated according to disclosed methods have number of advantages over conventional methods. For example, they have lower acidity than solid oxidizing products, when added to water. In particular, they have lower acidity than solid BCDMH.

Moreover, in situ generated stabilized oxidants according to embodiments have lower corrosion rates compared to in situ generated oxidants alone, which generally contain higher amounts of corrosive halide that lead to higher corrosion rates compared to commercially available oxidants (up to 3:1 chloride to chloride containing oxidant in a mixed oxidant). In situ stabilized oxidants according to embodiments exhibit corrosion rates of less than 1 mpy, 0.5 mpy, or 0.2 mpy, on yellow metals. Stabilized oxidants according to embodiments exhibit corrosion rates of less than 2 mpy, 1 mpy, or 0.5 mpy, on stainless steel. Stabilized oxidants according to embodiments exhibit corrosion rates of less than 6 mpy, 4 mpy, or 2.5 mpy, on mild steel.

In situ generated stabilized oxidants according to embodiments also exhibit a broader range of persistency throughout a water system. They may exhibit over 1.1×, 1.25×, or 1.5×, the half life of a BCDMH during application.

According to embodiments, a suitable ratio of the concentration of the in situ generated oxidant to the stabilizer in solution at the point of application is in a range of 0.2:1 to 8:1 by volume, preferably 1:1 to 5:1 by volume, and more preferably 1:1 to 3:1 by volume. The ratio of the stabilizer to oxidant and/or stabilizer to biodispersant may be determined based on the oxidant demand of the system. The concentration of the stabilizer fed to the system may also be based off of residual stabilizer levels.

The liquid treatment composition including the stabilizer liquid composition and in situ generated oxidant may be added to the water stream in the feed line or carry-water at a concentration in a range of 0.05 mg/L to 1,000 mg/L or 0.1 to 300 mg/L, preferably 1 to 10 mg/L, and more preferably 0.5 to 5 mg/L, relative to all components in the water stream.

Disclosed compositions and methods may be applied to any suitable water system. For example, the water system may include, but is not limited to, cooling water systems, cooling towers, evaporative cooling towers or swamp coolers, open chill water systems, surface condensers, scrubbers, heat exchangers, air washers, evaporative condensers, once-through cooling water systems, paper mill water systems, reverse osmosis system feedwaters, and brewery pasteurizers. Disclosed compositions and methods may be applied to systems that heat a fluid stream to in a range of 120 to 200° F., 130 to 190° F., or 140 to 185° F. Disclosed compositions and methods may be applied to pasteurizer including those having a pH under 7.5.

It will be appreciated that the above-disclosed features and functions, or alternatives thereof, may be desirably combined into different systems or methods. Also, various alternatives, modifications, variations or improvements may be subsequently made by those skilled in the art. As such, various changes may be made without departing from the spirit and scope of this disclosure.

What is claimed is:

1. A method for treating a water system, the method comprising:
mixing a stabilizer composition and an in situ generated oxidant to form a liquid treatment composition; and
then adding the liquid treatment composition to a water stream in the water system, the liquid treatment composition improving the efficacy of the in situ generated oxidant in the water stream,
wherein the stabilizer composition is added to the mixture in an amount sufficient to maintain a residual of the in situ generated oxidant in the water stream.

2. The method for treating a water system according to claim 1, wherein the in situ generated oxidant is formed from at least one compound selected from the group consisting of chloride, bromide, ammonium, chlorite, chlorate, hypochlorite, hypochlorous acid, hypobromite, hypobromous acid, peroxide, ozone chlorine dioxide, chlorite, sodium hypochlorite, chlorine gas, calcium hypochlorite, and a haloamine.

3. The method for treating a water system according to claim 1, wherein the in situ generated oxidant is formed from a haloamine.

4. The method for treating a water system according to claim 1, wherein the in situ generated oxidant is a mixed oxidant.

5. The method for treating a water system according to claim 4, wherein the mixed oxidant includes peroxide.

6. The method for treating a water system according to claim 1, wherein the stabilizer composition includes a compound selected from the group consisting of an unhalogentaed hydantoin, cyanuric acid, or sulfamic acid.

7. The method for treating a water system according to claim 1, wherein the stabilizer composition includes sulfamic acid.

8. The method for treating a water system according to claim 1, wherein a molar ratio of a concentration of the in situ generated oxidant to the stabilizer composition in the liquid treatment composition is in a range of 0.01:1 to 20:1.

9. The method for treating a water system according to claim 1, wherein a molar ratio of a concentration of the in situ generated oxidant to the stabilizer composition in the liquid treatment composition is in a range of 1:1 to 10:1.

10. The method for treating a water system according to claim 1, wherein a concentration of the in situ generated oxidants in the liquid treatment composition is in a range of 0.01 to 100 ppm.

11. The method for treating a water system according to claim 1, wherein a concentration of the in situ generated oxidants in the liquid treatment composition is in a range of 0.1 to 25 ppm.

12. The method for treating a water system according to claim 1, wherein a concentration of the stabilizer composition in the liquid treatment composition is in a range of 0.005 to 100 ppm.

13. The method for treating a water system according to claim 1, wherein a concentration of the stabilizer composition in the liquid treatment composition is in a range of 0.01 to 25 ppm.

14. The method for treating a water system according to claim 1, wherein the amount sufficient to maintain the residual of the in situ generated oxidant in the water stream is determined based on a system demand of the water system.

15. The method for treating a water system according to claim 14, wherein the system demand is at least one of a flow rate of the system and an oxidant demand of the system.

16. The method for treating a water system according to claim 1, wherein the stabilizer composition includes a biodispersant having a hydrophilic-lipophilic balance of 40 or less.

17. The method for treating a water system according to claim 16, wherein the biodispersant is present in the stabilizer composition at a concentration in a range of 0.01 to 50 ppm.

18. The method for treating a water system according to claim 1, wherein the stabilizer composition is mixed with the in situ generated oxidant on site to form the liquid treatment composition; and
the liquid treatment composition is added to the water stream in the water system by injecting the liquid treatment composition into the water stream of the water system.

19. The method for treating a water system according to claim 1, wherein the liquid treatment composition forms at least one stabilized oxidant selected from the group consisting of ClHDMH, Cl₂DMH, ClBrDMH, BrHDMH, Br₂DMH, Cl sulfamic, Br sulfamic, ClH₂ cyanurate, BrH₂ cyanurate, Cl₂H cyanurate, Br₂H cyanurate, and ClBrH cyanurate.

20. The method for stabilizing a oxidizing biocide according to claim 1, wherein the water system is selected from the group consisting of cooling water systems, cooling towers, evaporative cooling towers or swamp coolers, open chill water systems, surface condensers, scrubbers, heat exchangers, air washers, evaporative condensers, once-through cooling water systems, paper mill water systems, reverse osmosis system feedwaters, and brewery pasteurizers.
